(19) United States
(12) Patent Application Publication
(10) Pub. No.: US 2026/0183981 A1
(43) Pub. Date: Jul. 2, 2026

(54) CUTTING APPARATUS AND IMAGE RECORDING APPARATUS

(71) Applicant: BROTHER KOGYO KABUSHIKI KAISHA, Nagoya (JP)

(72) Inventors: Yuki TSUJIMURA, Konan (JP); Wataru SUGIYAMA, Nishio (JP)

(73) Assignee: BROTHER KOGYO KABUSHIKI KAISHA, Nagoya (JP)

(21) Appl. No.: 19/430,423

(22) Filed: Dec. 23, 2025

(30) Foreign Application Priority Data
Dec. 26, 2024 (JP) 2024-231040

(51) Int. Cl. B26D 5/00; B41J 11/70; B41J 15/04

(52) U.S. Cl. CPC B26D 5/007; B41J 11/706; B41J 15/046

(57) ABSTRACT

A cutting apparatus includes: a conveyor; a cutting part including a first cutter, a second cutter, and a moving mechanism; and a first guide. The first cutter has a first base portion and a first end protruding from the first base portion in a second direction. The first end contacts an end of the second cutter in a case where the medium is cut at a cutting position. The conveyor has a holding part holding the medium at a holding position downstream of the cutting position in the conveying direction. A first guide surface of the first guide has a portion disposed upstream of a first virtual line in the second direction, the first virtual line extending in a third direction orthogonal to both the first and second directions and passing through the first end of the first cutter in the case where the cutting part cuts the sheet.

### REFERENCE TO RELATED APPLICATIONS

This application claims priority from Japanese Patent Application No. 2024-231040 filed on Dec. 26, 2024. The entire content of the priority application is incorporated herein by reference.

### BACKGROUND ART

The present disclosure relates to a cutting apparatus and an image recording apparatus each of which includes a first cutter and a second cutter configured to cut a medium in sheet form.

A known cutter mechanism includes a movable blade capable of contacting one surface of a recording sheet, a fixed blade capable of contacting the other surface of the recording sheet, and a guide facing the movable blade, with a sheet path being interposed between the guide and the movable blade.

### SUMMARY

In a certain known cutter mechanism, in a case where a recording sheet is to be cut at a cutting position at which a movable blade contacts a fixed blade, the movable blade cuts the recording sheet while pressing the recording sheet toward the fixed blade. Although the guide has a portion positioned while being oriented in a direction in which the fixed blade is disposed relative to the movable blade, this portion is disposed, in a region in the vicinity of the cutting position, away from an end of the movable blade in the case where the recording sheet is cut. In this case, the recording sheet is likely to be deflected, in the vicinity of the cutting position, in a direction from the movable blade toward the fixed blade. This might easily result in unsatisfactory cutting of the recording sheet, and might cause the cutting of the recording sheet to be unstable.

In view of the above-described situation, the present disclosure aims to provide a cutting apparatus and an image recording apparatus capable of contributing to stable cutting of a medium in sheet form.

A cutting apparatus according to an aspect of the present disclosure includes: a conveyor configured to convey a medium in sheet form in a conveying direction and along a conveyance path; a cutting part including a first cutter configured to contact one surface of the medium which is conveyed by the conveyor, a second cutter configured to contact the other surface of the medium, and a moving mechanism configured to move one or both of the first cutter and the second cutter, the cutting part being configured to cut, with the first cutter and the second cutter, the medium in a first direction intersecting the conveying direction at a cutting position in the conveyance path; and a first guide having a first guide surface facing the other surface of the medium, wherein: the first cutter has a first base portion and a first end protruding from the first base portion in a second direction intersecting both the conveying direction and the first direction, the first end contacting an end of the second cutter in a case where the cutting part cuts the sheet; the conveyor has a holding part configured to hold the medium at a holding position defined downstream of the cutting position in the conveying direction; and the first guide surface has a portion disposed upstream of a first virtual line in the second direction in a region, in the conveyance path, between the cutting position and an intermediate position which is between the holding position and the cutting position, the first virtual line extending in a third direction orthogonal to both the first direction and the second direction and passing through the first end of the first cutter in the case where the cutting part cuts the sheet.

An image recording apparatus according to another aspect of the present disclosure includes: a conveyor configured to convey a medium in sheet form in a conveying direction and along a conveyance path; a recording part configured to record an image on the medium which is conveyed by the conveyor; a cutting part including a first cutter configured to contact one surface of the medium which is conveyed by the conveyor, a second cutter configured to contact the other surface of the medium, and a moving mechanism configured to move one or both of the first cutter and the second cutter, the cutting part being configured to cut, with the first cutter and the second cutter, the medium in a first direction intersecting the conveying direction at a cutting position in the conveyance path; and a first guide having a first guide surface facing the other surface of the medium, wherein: the first cutter has a first base portion and a first end protruding from the first base portion in a second direction intersecting both the conveying direction and the first direction, the first end contacting an end of the second cutter in the case where the cutting part cuts the sheet; the conveyor has a holding part configured to hold the medium at a holding position upstream of the recording part in the conveying direction and downstream of the cutting position in the conveying direction; and the first guide surface has a portion disposed upstream of a first virtual line in the second direction in a region, in the conveyance path, between the cutting position and an intermediate position which is between the holding position and the cutting position, the first virtual line extending in a third direction orthogonal to both the first direction and the second direction and passing through the first end of the first cutter in the case where the cutting part cuts the sheet.

According to the cutting apparatus and the image recording apparatus of the present disclosure, in a case where the cutting part cuts the medium in sheet form and even in a case where the first cutter pushes the medium in sheet form downstream in the second direction, the medium in sheet form is less likely to be deflected, since the location in the vicinity of a portion, in the medium sheet form, which is pushed by the first cutter contacts the above-described portion of the first guide surface. Accordingly, the medium in sheet form can be cut stably.

### BRIEF DESCRIPTION OF DRAWINGS

FIG. 1 is a perspective view of a printer according to an embodiment of the present disclosure.

FIG. 2 is a schematic side view illustrating the inner structure of the printer.

FIG. 3 is a schematic side view corresponding to FIG. 2 and illustrating a state where cut sheets are accommodated inside a sheet feed tray in the printer.

FIG. 4 is a perspective view illustrating a cutter unit and a scanning mechanism included in the printer.

FIG. 5A is a partially enlarged view of the cutter unit and parts or components disposed in the vicinity of the cutter unit, and FIG. 5B is an enlarged view of a region E in FIG. 5A.

FIG. 6 is a schematic view illustrating the disposition of guide rails 52X and 52Y, cutters 60 and 70, a first guide 7, and a second guide 8 as viewed from a direction D2.

FIG. 7A is a cross-sectional view along a VIIa-VIIa line illustrated in FIG. 5B, and FIG. 7B is a cross-sectional view along a VIIb-VIIb line illustrated in FIG. 5B.

### DESCRIPTION

### Overall Configuration of Printer

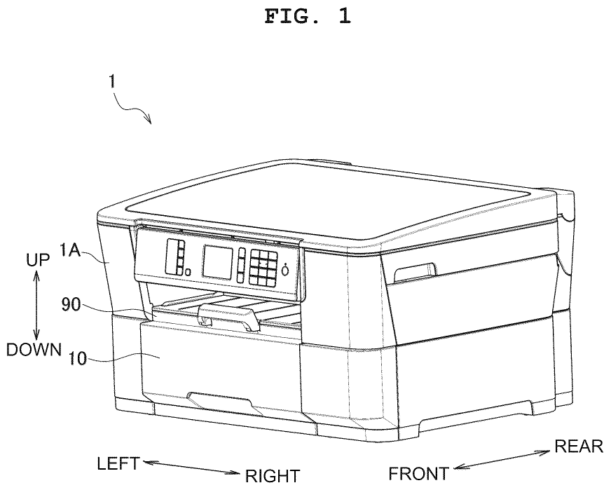

A printer 1 according to an embodiment of the present disclosure includes a casing 1A, a sheet feed tray 10 detachably attached to the casing 1A, and a sheet discharge tray 90, as illustrated in FIG. 1.

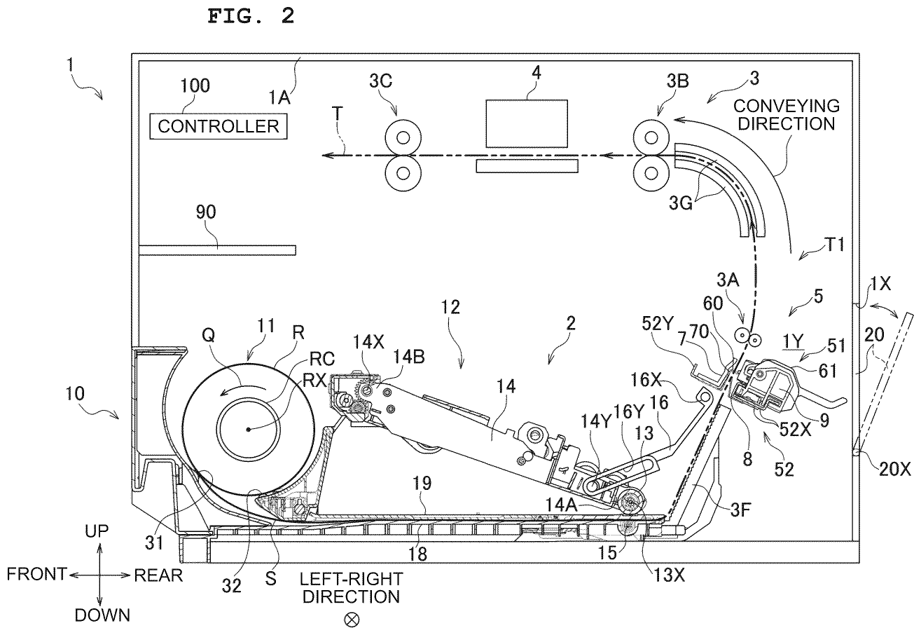

The printer 1 further includes a conveyor 3, a head 4, a cutting part 5, a first guide 7, a second guide 8, and a controller 100, as illustrated in FIG. 2. The head 4, the cutting part 5, the first guide 7, the second guide 8, the controller 100, and elements constructing the conveyor 3 and different from rollers 31 and 32 which will be described later are supported by the casing 1A. The rollers 31 and 32 are supported by the sheet feed tray 10. The printer 1 corresponds to an “image recording apparatus” and a “cutting apparatus” of the present disclosure.

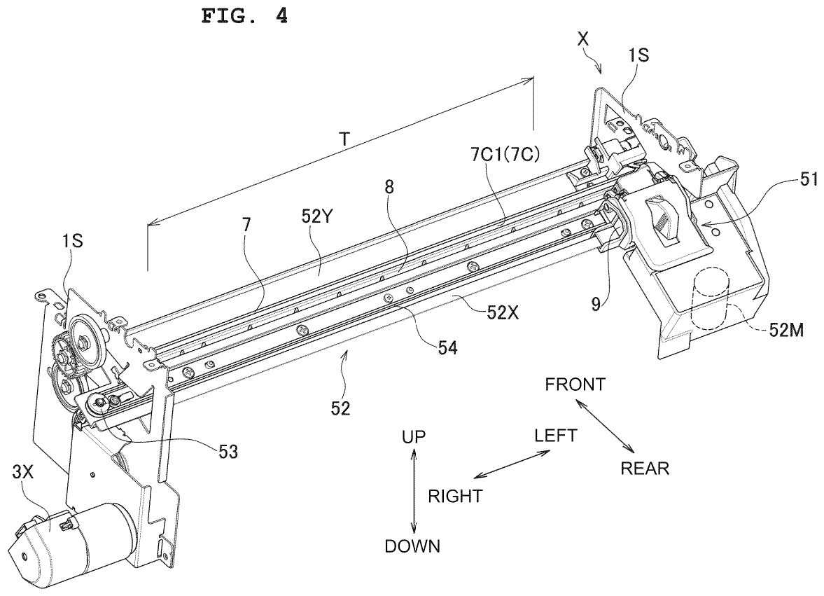

The conveyor 3 is configured to convey a sheet S along a conveyance path T in a conveying direction, and includes the rollers 31 and 32, a roller 13 and an arm 14, a guide member 16, a separation member 3F, roller pairs 3A to 3C, a pair of guide members 3G, and a conveying motor 3X (see FIG. 4) configured to drive each of the above-described rollers.

In the conveyor 3, the rollers 31 and 32, the roller 13, and the arm 14 construct a feeding part 2 capable of feeding the sheet S stored in the sheet feed tray 10 toward the conveyance path T.

The conveyance path T is a path in which the sheet S fed from the sheet feed tray 10 passes between the pairs of guide members 3G, passes a location below the head 4, and moves toward the sheet discharge tray 90. The conveyance path T has a U-shaped curved portion T1 disposed upstream in the conveying direction of the head 4. The separation member 3F, the cutting part 5, the first guide 7, the second guide 8, the roller pair 3A, and the pair of guide members 3G are disposed in the curved portion T. The cutting part 5, the first guide 7, the second guide 8, and the roller pair 3A are disposed in a bottom portion of the curved portion T1. The cutting part 5, the first guide 7, and the second guide 8 are disposed downstream in the conveying direction of the separation member 3F and disposed upstream in the conveying direction of the roller pair 3A.

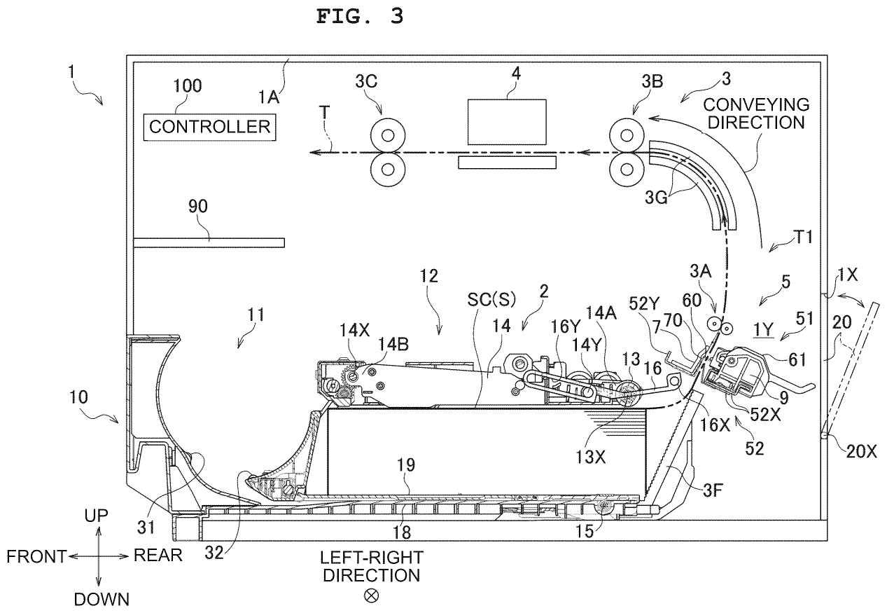

The sheet feed tray 10 includes a roll sheet accommodating part 11 capable of accommodating a roll sheet R (see FIG. 2) and a cut sheet accommodating part 12 capable of accommodating a plurality of cut sheets SC (see FIG. 3) in a state where the plurality of cut sheets SC are stacked in the up-down direction. The cut sheets SC accommodated in the cut sheet accommodating part 12 are supported on the upper surface of a support plate 19 disposed along a bottom plate 18 of the sheet feed tray 10.

In the sheet feed tray 10, the cut sheets SC are removed from the cut sheet accommodating part 12 in a case where the roll sheet R is used (see FIG. 2), and the roll sheet R is removed from the roll sheet accommodating part 11 in a case where the cut sheets SC are used (see FIG. 3). In the sheet feed tray 10, the cut sheet accommodating part 12 is disposed behind the roll sheet accommodating part 11.

The sheet S is a generic term for a sheet unwound from the roll sheet R and the cut sheets SC, and corresponds to a “medium in sheet form” of the present disclosure. Each of the cut sheets SC is a sheet of which length along the conveyance path T is shorter than the length along the conveyance path of the sheet constructing the roll sheet R.

The roll sheet R is a long sheet S wound in a roll shape around the outer circumferential surface of a cylindrical core member RC. The roll sheet R is accommodated in the roll sheet accommodating part 11 in a state where a rotational axis RX (the central axis of the core member RC) of the roll sheet S is aligned along the left-right direction. The left-right direction is parallel to the sheet S along the conveyance path T and intersects the conveying direction. The left-right direction in the present embodiment is parallel to the width direction of the sheet S and corresponds to a “first direction” of the present disclosure.

The rollers 31 and 32 are disposed at a bottom portion of the roll sheet accommodating part 11. Each of the rollers 31 and 32 is rotatable about a shaft which is along the left-right direction. In a case where the roll sheet R is accommodated in the roll sheet accommodating part 11, the lower outer circumferential surface of the roll sheet R is supported by the rollers 31 and 32. In a case where a user causes the roll sheet R to be in a state where the roll sheet R can be fed, the user manually rotates the roll sheet R in a direction of an arrow Q illustrated in FIG. 2 so as to unwind the sheet S from the roll sheet R. Then, the sheet S which is being unwound from the roll sheet R is caused to pass through a clearance between the lower surface of the supporting plate 19 and the upper surface of the bottom plate 18 so that the leading edge of the sheet S is held between the roller 13 and a roller 15. The user, upon confirming that the leading edge of the sheet S is in a state of being held between the roller 13 and a roller 15, ends the operation of manually rotating the roll sheet R. In this state, in response to the conveying motor 3X (see FIG. 4) being driven under the control of the controller 100, the roller 13 rotates so as to feed the sheet S, unwound from roll sheet R, rearward.

The roller 13 is supported by one end 14A of the arm 14 and is rotatable about a shaft 13X which is along the left-right direction. The other end 14B of the arm 14 is supported by the casing 1A via a shaft 14X which is along the left-right direction. The arm 14 is pivotable about the shaft 14X, with the other end 14B as the fulcrum (see FIGS. 2 and 3).

In a case where the plurality of cut sheets SC are not accommodated in the cut sheet accommodating part 12 in a state where the sheet feed tray 10 is attached to the casing 1A, the roller 13 contacts the upper surface of the supporting plate 19 (see FIG. 2). In a case where the plurality of cut sheets SC are accommodated in the cut sheet accommodating part 12 in the state where the sheet feed tray 10 is attached to the casing 1A, the roller 13 contacts an uppermost cut sheet SC among the plurality of cut sheets SC accommodated in the cut sheet accommodating part 12 (see FIG. 3). In this situation, in response to the conveying motor 3X (see FIG. 4) being driven under the control of the controller 100, the roller 13 rotates so as to feed the uppermost cut sheet SC rearward.

The sheet S fed from sheet feed tray 10 by the roller 13, i.e., the sheet S unwound from the roll sheet R accommodated in the roll sheet accommodating part 11 and fed by the roller 13, or a cut sheet SC, among the cut sheets SC accommodated in the cut sheet accommodating part 12 and fed by the roller 13, enters the conveyance path T. The sheet S which has entered the conveyance path T contacts the separation member 3F, moves along the separation member 3F, and is guided to the first guide 7, the second guide 8, and the cutting part 5.

The separation member 3F and the guide member 16 define the conveyance path T at a location behind the sheet feed tray 10. The separation member 3F is disposed behind the roller 13 and extends in an oblique direction intersecting both the up-down direction and the front-rear direction. A surface of the separation member 3F has fine irregularities formed in the surface and repeating along the conveyance path T. The fine irregularities are configured to prevent multiple feed. The multiple feed refers to a plurality of cut sheets being conveyed in a stacked state. That is, the separation member 3F has a function of separating a certain cut sheet SC contacting with the roller 13 from cut sheet(s) SC other than the certain cut sheet SC.

The guide member 16 has a bent shape and has one end in which a rotational shaft 16X along the left-right direction is disposed, and the other end through which a long hole 16Y extends. A convex portion 14Y defined at a location in the vicinity of the one end 14A of the arm 14 is inserted in the long hole 16Y. In response to the arm 14 being pivoted so as to move the convex portion 14Y along the long hole 16Y, the guide member 16 rotates about the rotational shaft 16X, as illustrated in FIGS. 2 and 3. The rotational shaft 16X is disposed between the sheet feed tray 10 and the cutting part 5 in the conveyance path T.

The head 4 includes a plurality of nozzles (not illustrated in the drawings) extending through the lower surface of the head 4, and a driver IC (not illustrated in the drawings). The head 4 in the present embodiment corresponds to a “recording part” of the present disclosure. In a case where the sheet S conveyed by the conveyor 3 passes through a position facing the lower surface of the head 4, the driver IC is driven under the control of the controller 100, causing ink to be ejected from the plurality of nozzles, and the ink lands on the sheet S, thereby recording an image on the sheet S. Note that the head 4 may be either a head of the line type which ejects the ink from the plurality of nozzles in a state where the position of the head 4 is fixed, or a head of the serial type which ejects the ink from the plurality of nozzles while the head 4 is moving in the left-right direction.

The cutting part 5 has a cutter unit 51, a scanning mechanism 52, a guide rail 52Y, and a cutter 70. The cutter unit 51 is configured to cut the sheet S unwound from the roll sheet R, at a location between the separation member 3F and the roller pair 3A in the conveyance path T. The cutter unit 51 includes a cutter 60, and a holder 61 which rotatably supports the cutter 60. The cutter unit 51 is detachably attached to a carriage 9 which is supported by the casing 1A. The cutter 60 in the present embodiment corresponds to a “first cutter” of the present disclosure. The scanning mechanism 52 corresponds to a “moving mechanism” of the present disclosure.

As illustrated in FIG. 4, the scanning mechanism 52 includes the carriage 9, a guide rail 52X, and a pair of pulleys 53 (only one of the pair of pulleys 53 is illustrated in FIG. 4), a belt 54, and a cutting motor 52M. The guide rail 52X is elongated and extends in the left-right direction. The belt 54 is wound around the pair of pulleys 53. The carriage 9 is attached to the belt 54. The pair of pulleys 53, the belt 54 and the cutting motor 52M are attached to the guide rail 52X. The guide rail 52X supports the carriage 9 attached to the belt 54 and the cutter unit 51 attached to the carriage 9.

In response to the cutting motor being driven, the belt 9 runs, which in turn moves the carriage 9 in the left-right direction. The guide rail 52X guides the carriage 9 which is moving in the left-right direction. Thus, the scanning mechanism 52 moves carriage 9 in the left-right direction so as to move the cutter unit 51 attached to the carriage 9 in the left-right direction. In other words, the scanning mechanism 52 moves the cutter 60 in the left-right direction.

The guide rail 52Y is disposed in front of the guide rail 52X and at a position facing the guide rail 52X, with the conveyance path T (see FIG. 2) being interposed between the guide rails 52Y and 52X. The guide rail 52Y extends in the left-right direction, and is apart from the guide rail 52X in the front-rear direction. The conveyance path T is defined between the guide rail 52X and the guide rail 52Y in the front-rear direction.

The guide rails 52X and 52Y are fixed to two side frames 1S via, for example, screws, as illustrated in FIG. 4. The two side frames 1S are a part of the casing 1A and are made, for example, of metal. The two side frames 1S are apart from each other in the left-right direction, and support the left ends of the guide rails 52X and 52Y and the right ends of the guide rails 52X and 52Y, respectively.

The guide rail 52Y supports the cutter 70. The cutter 70 in the present embodiment corresponds to a “second cutter” of the present disclosure, and the guide rail 52Y in the present embodiment corresponds to a “supporting part” of the present disclosure.

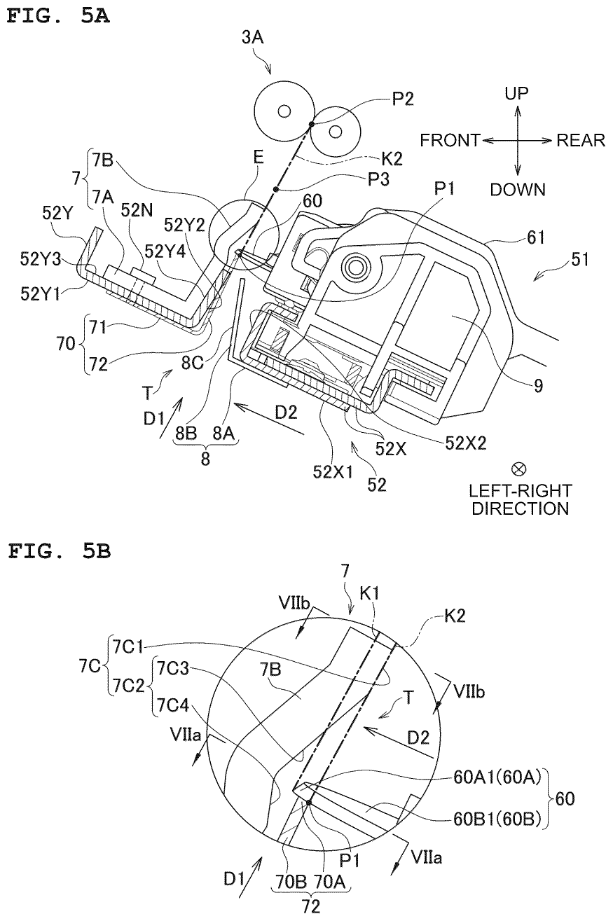

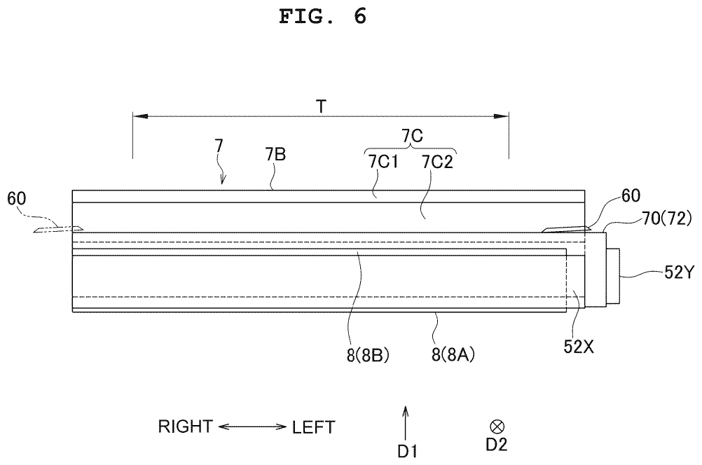

As illustrated in FIG. 5A, the cutter 70 is L-shaped, and has a first portion 71 covering a lower surface 52Y1 of the guide rail 52Y and a second portion 72 covering a side surface 52Y2, of the guide rail 52Y, which faces the guide rail 52X. The first portion 71 of the cutter 70 is attached to the guide rail 52Y with a screws 52N, thereby fixing the cutter 70 to the guide rail 52Y. As illustrated in FIG. 6, the cutter 70 is elongated and extends along the guide rail 52Y.

The second portion 72 has a blade portion 70A and a base portion 70B, as illustrated in FIG. 5B. The base portion 70B extends along the conveyance path T and defines a portion of the conveyance path T. More specifically, the base portion 70B extends along a direction D1. The direction D1 is the same direction as the conveying direction in the vicinity of the cutting part 5, and is orthogonal to both the left-right direction and a direction D2 which will be described later. The direction D1 in the present embodiment corresponds to a “third direction” of the present disclosure. The blade portion 70A is disposed in a downstream end part in the direction D1 of the base portion 70B and is disposed in an upper end of the base portion 70B. The second portion 72, i. e. the cutter 70, contacts the sheet S which is being conveyed through the conveyance path T defined by the separation member 3F and the guide member 16, and guides the sheet S downstream in the conveying direction.

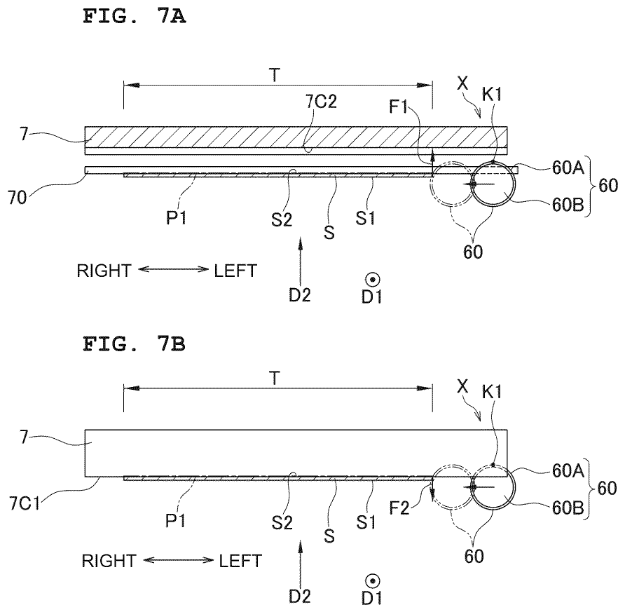

As illustrated in FIG. 7, the cutter 60 has a blade portion 60A and a base portion 60B. The base portion 60B has a disc shape. The blade portion 60A is annularly formed in the peripheral edge of the base portion 60B. In other words, the blade portion 60A is formed to protrude from the peripheral edge of the base portion 60B in the radial direction of the base portion 60B. With this, as illustrated in FIGS. 5A and 5B, a portion 60A1, of the blade portion 60A, which is the closest to the cutter 70 protrudes from a portion 60B1, of the base portion 60B, which is the closest to the cutter 70 in a direction D2 as a direction from the cutter 60 toward the cutter 70. The direction D2 is parallel to the radial direction and intersects both the direction D1 and the left-right direction. The direction D2 in the present embodiment corresponds to a “second direction” of the present disclosure. The base portion 60B corresponds to a “first base portion” of the present disclosure, and the blade portion 60A corresponds to a “first end” of the present disclosure.

The cutter 70 is fixed, whereas the cutter 60 is rotatable. Further, the cutter 70 is supported by the casing 1A, whereas the cutter 60, together with the holder 61, is detachably attached with respect to the carriage 9, i.e., with respect to the casing 1A. The cutter unit 51 including the cutter 60 is selectively switchable between an attached state where the cutter 60 is attached to the casing 1A at an attached position X (see FIG. 4), and a detached state where the cutter unit 51 is detached from the attached position X.

The cutter 60 may contact one surface S1 (see FIG. 7) of the sheet S which is conveyed by the conveyor 3. On the other hand, the cutter 70 contacts the other surface S2 (see FIG. 7) of the sheet S which is conveyed by the conveyor 3. Further, the cutter 60 in the attached state cooperates with the cutter 70 so as to cut the sheet S which is conveyed by the conveyor 3. In a case where the sheet S is cut by the cutters 60 and 70, the sheet S is cut by the cutters 60 and 70 in a state where the sheet S is held between the roller 13 and the roller 15 at a location upstream of the cutters 60 and 70 in the conveying direction, and where the sheet S is held between the roller pair 3A at a location downstream of the cutters 60 and 70 in the conveying direction. The cutter 60 and the cutter 70 in the present embodiment are used to cut the sheet S unwound from the roll sheet R, and are not used to cut the cut sheet CS. Although both the cutters 60 and 70 are made of a metal material, both the cutters 60 and 70 may be made of another material different from the metal material, provided that both the cutters 60 and 70 are capable of cutting the medium in sheet form.

In a case where the sheet S is to be cut, the blade portion 60A of the cutter 60 is disposed downstream in the direction D1 of the blade portion 70A of the cutter 70, as illustrated in FIGS. 5A and 5B, and overlaps the blade portion 70A of the cutter 70 in the direction D1. The cutter 60 is attached to the holder 61 in a posture wherein the cutter 60 is not parallel to the left-right direction, but is inclined in a direction obliquely downward to the right, as illustrated in FIG. 6. Therefore, in a case where the cutter 60 is in the attached state where the cutter 60 is attached to the casing 1A, a right end portion of the cutter 60 contacts the end of the blade portion 70A of the cutter 70. The sheet S, which is located in the conveyance path T, is cut at a corner portion of a contact portion at which the cutter 60 and the cutter 70 contact each other, the corner portion being adjacent to the conveyance path T. In other words, a cutting position P1 of the sheet S in the present embodiment is defined at an upper end corner portion, of the blade portion 70, which is on the upstream side in the direction D2, as illustrated in FIGS. 5A and 5B and FIG. 7A. Note that in FIG. 7A, the cutting position P1 is indicated by a dotted line.

Further, in a case where the sheet S is to be cut, the cutter 60 protrudes downstream of the cutting position P1 in the direction D2. More specifically, as illustrated in FIG. 5B, the portion 60A1, of blade portion 60A of cutter 60, which is the closest to the cutter 70 protrudes downstream of the cutter 70 in the direction D2.

In response to the cutting motor 52M (see FIG. 4) being driven under the control of the controller 100, the belt 54 runs in the left-right direction so as to move the carriage 9 and the cutter unit 51 attached to the carriage 9 from the attached position X outside the conveyance path T to the inside of the conveyance path T.

The attached position X is at the left end of each of the guide rails 52X and 52Y, as illustrated in FIG. 4, and is a home position at the beginning and end of movement of the carriage 9 as described above, as well as a position at which the holder 61 is attached or detached with respect to the carriage 9.

In response to the carriage 9 being moved, the cutter 60 rotates, following the movement of the carriage 9, driven by a rotational moment received from the sheet S unwound from the roll sheet S and the cutter 70. As a result, the cutter 60 and the cutter 70 cooperate to cut the sheet S unwound from roll sheet R in the left-right direction, which is the width direction of the sheet S, at the cutting position P1.

An opening 1X (see FIG. 2) is defined in the rear wall of the casing 1A. The opening 1X communicates an accommodating space 1Y, of the casing 1A, which accommodates the cutting part 5, with the outside of the casing 1A. Namely, the carriage 9 located at the attached position X of the accommodating space 1Y is exposed to the outside of the casing 1A via the opening 1X. The opening 1X is defined at a portion, of the casing 1A, which faces the bottom portion of the above-described curved portion T1.

A cover 20 configured to cover the opening 1X is attached to the rear wall of the casing 1A. The cover 20 is pivotable about a shaft 20X which is disposed in a lower end of the opening 1X and which is along the left-right direction. By pivoting on the shaft 20X, the cover 20 is selectively switchable between a closed position (see solid lines in FIG. 2) at which the cover 20 closes the opening X1 and at an open position (see double-dotted lines in FIG. 2) at which the cover 20 opens the opening 1X.

By locating the cover 20 at the open position (see the two-dot-chain lines in FIG. 2), the cutter unit 51 can be attached to or detached from the carriage 9 at the attached position X via the opening 1X. In the front-rear direction, the cutter 60 is positioned closer to the opening 1X than the cutter 70 is. Namely, the cutter unit 51 is closer to the opening 1X than the cutter 70 is. With this, the cutter 60 can be exchanged easily through the opening 1X of the casing 1A.

The first guide 7 is disposed to face the holder 61 in the direction D2, as illustrated in FIG. 5A. The first guide 7 is L-shaped and has a first portion 7A covering a bottom surface 52Y3 of the guide rail 52Y and a second portion 7B covering an inner side surface 52Y4 of the guide rail 52Y. The first portion 7A is fixed to the guide rail 52Y with the screw 52N to thereby fix the first guide 7 to the casing 1A. Namely, the first guide 7 and the cutter 70 are fixed to the guide rail 52Y with the common screw 52N. Therefore, the configuration for fixing the first guide 7 and the cutter 70 to the guide rail 52Y can be simplified.

The first guide 7 is elongated and extends along the guide rail 52Y in the left-right direction, as illustrated in FIG. 6. The first guide 7 is longer than the conveyance path T in the left-right direction, and the left end and the right end of the first guide 7 are disposed outside the conveyance path T in the left-right direction.

The second portion 7B extends along the conveyance path T, as illustrated in FIG. 5A. More specifically, as illustrated in FIGS. 5A and 5B, the second portion 7B extends from a location upstream of the cutting position P1 toward a location downstream of the cutting position P1 in the direction D1, and has a guide surface 7C defining a portion of the conveyance path T. The guide surface 7C corresponds to a “first guide surface” of the present disclosure.

The first guide 7 is disposed inside the guide rail 52Y. The second portion 7B of the first guide 7 is disposed side by side with the second portion 72 of the cutter 70, with the guide rail 52Y being interposed between the second portion 7B of the first guide 7 and the second portion 72 of the cutter 70 in the direction D2. The second portion 7B of the first guide 7 extends in the direction D1 together with the second portion 72 of the cutter 70. Therefore, the first guide 7 can be disposed, in a state where the second portion 7B is aligned with the second portion 72 of the cutter 70. With this, the first guide 7 can be easily disposed.

The guide surface 7C is formed at a portion, of the first guide 7, located above the inner side surface 52Y4 of the second portion 7B in the direction D1, and guides the other surface S2 of the sheet S which is (being) conveyed along the conveyance path T. The guide surface 7C has a pressing surface 7C1 and a recessed portion 7C2. The recessed portion 7C2 is a recess defined by an upper inclined surface 7C3 and a lower inclined surface 7C4, and is recessed in the direction D2. The recessed portion 7C2 is disposed upstream of the pressing surface 7C1 in the direction D1. The recessed portion 7C2 is located at a position facing the cutter 60 in the direction D2. The recessed portion 7C2 is located at a position facing the cutting position P1 in the direction D2. Further, the recessed portion 7C2 is recessed downstream in the direction D2 so that the recessed portion 7C2 is apart, in the direction D2, from a downstream end of the blade portion 60A of the cutter 60.

The pressing surface 7C1 extends, along the direction D1, from a downstream end of the recessed portion 7C2 up to a downstream end of the first guide 7. The pressing surface 7C1 is disposed in a region, in the conveyance path T, between the cutting position P1 and an intermediate position P3 which is between the cutting position P1 and a holding position P2 at which the sheet S is held by the roller pair 3A. The holding position P2 is defined downstream of the cutting position P1 in the direction D1. The pressing surface 7C1 is disposed upstream of a virtual line K1 in the direction D2. The virtual line K1 is a line extending in the direction D1 passing through the downstream end in the direction D2 of the blade portion 60A of the cutter 60 in a case where the cutting sheet S is (being) cut, as illustrated in FIG. 5B. The virtual line K1 corresponds to a “first virtual line” of the present disclosure. Further, the pressing surface 7C1 corresponds to a “portion located upstream of the second direction (of a first virtual line)” of the present disclosure. Furthermore, the roller pair 3A corresponds to a “holding part” of the present disclosure.

Moreover, the pressing surface 7C1 is disposed on a virtual line K2 as illustrated in FIG. 5. The virtual line K2 is a straight line which is along the conveyance path T and which connects the cutting position P1 and the holding position P2. The virtual line K2 corresponds to a “second virtual line” of the present disclosure.

A situation in a case where the sheet S is cut with the cutter 60 and the cutter 70 will be described, with reference to FIGS. 7A and 7B. Since the blade portion 60A of the cutter 60 is disposed downstream of the cutting position P1 in the direction D2, as illustrated in FIG. 5B and FIG. 7A, a force F1 in the direction D2 acts on a portion, of the sheet S, with which the cutter 60 makes contact. In other words, in a case where the sheet S is being cut, particularly in a case where a sheet S having low stiffness is being cut, a portion, of the sheet S, which is in contact with the cutter 60 is pushed in the direction D2 to be deflected, and tends to be away from the cutter 60. However, as illustrated in FIGS. 5A and 7B, the pressing surface 7C1 of the first guide 7 is disposed in the vicinity of the cutting position P1 and on the virtual line K2. Therefore, even in a case where the force F1 in the direction D2 acts on the sheet S, the pressing surface 7C1 applies a reaction force F2 in the opposite direction of the direction D2 to the sheet S. As a result, even in a case where the sheet S is pushed in the direction D2 by the cutter 60, the sheet S is less likely to be deflected in the direction D2, and the sheet S can be cut smoothly by the cutter 60 and the cutter 70. Note that in a case where the sheet S is being cut with the cutter 60 and the cutter 70, a rightward force also acts on the portion, of the sheet S, with which the cutter 60 makes contact.

The second guide 8 is disposed to face the second portion 72 of the cutter 70 in the direction D2, as illustrated in FIG. 5A. The second guide 8 is also substantially L-shaped, and has a first portion 8A covering a bottom surface 52X1 of the guide rail 52X and a second portion 8B covering a side surface 52X2, of the guide rail 52X, which faces the guide rail 52Y. The first portion 8A is adhered to the bottom surface 52X1 of the guide rail 52X with a non-illustrated double-sided adhesive tape, thereby fixing the second guide 8 to the guide rail 52X. Note that the second guide 8 may be fixed to the guide rail 52X with, for example, a screw, rather than the double-sided adhesive tape, provided that the second guide 8 can be fixed to the guide rail 52X.

The second guide 8 in the present embodiment is a thin plate member made of a resin material such as polyethylene terephthalate. The second guide 8 is flexible. The second guide 8 is elongated and extends along the guide rail 52X, as illustrated in FIG. 6. The second guide 8 is longer than the conveyance path T in the left-right direction, and the left end and the right end of the second guide 8 are each positioned outside the conveyance path T in the left-right direction.

The second portion 8B extends upward from a downstream end in the direction D2 of the first portion 8A, as illustrated in FIG. 5A, and has a guide surface 8C defining a portion of the conveyance path T. The guide surface 8C corresponds to a “second guide surface” of the present disclosure.

The guide surface 8C faces the second portion 72 of the cutter 70 in the direction D2. A portion of the conveyance path T is defined between the guide surface 8C and the second portion 72. The guide surface 8C guides the one surface S1 of the sheet S. Further, the guide surface 8C is disposed with respect to the direction D1 so that the guide surface 8C is inclined further downstream in the direction D2 as the guide surface 8C extends downstream in the direction D1. In other words, the guide surface 8C is disposed to be inclined with respect to the direction D1 so that the guide surface 8C extends further downstream in the direction D2 as the guide surface 8C extends downstream in the direction D1. With this, the sheet S which is being conveyed by the conveyor 3 can be guided smoothly to the cutting position P1.

The second portion 8B of the second guide 8 is flexible and is configured to be displaceable in a direction intersecting the guide surface 8C. As a result, even in a case where sheets S of different thicknesses are to be conveyed, the second portion 8B, which is displaced in accordance with the thickness of each of the sheets S having the different thicknesses, is capable of guiding each of the sheets S having the different thicknesses smoothly to the cutting position P1.

As described above, according to the printer 1 of the present embodiment, in a case where the sheet S is being cut by the cutting part S and even in a case where the sheet S is pushed downstream in the direction D2 by the cutter 60, the sheet S is less likely to be deflected because the location, in the sheet S, in the vicinity of the portion pushed by the cutter 60 contacts the pressing surface 7C1 of the guide surface 7C. Accordingly, the sheet S can be cut stably.

The scanning mechanism 52 moves the cutter 60 in the left-right direction. With this, the scanning mechanism 52 simply moves the cutter 60 rightward from the home position so that the sheet S can be cut. Accordingly, the cutter 60 can be downsized in the left-right direction. For example, in a guillotine-type configuration in which a cutter 60 which is elongated and extends in the left-right direction is moved toward the cutter 70 in the direction D2 to thereby cut a sheet S, the cutter 60 becomes large-sized in the left-right direction. In contrast, in the configuration of the present embodiment, the cutter 60 can be downsized in the left-right direction.

The recessed portion 7C2 is defined in the guide surface 7C. With this, the end of the cutter 60 is prevented from contacting the guide surface 7C in a case where the sheet S is to be cut in the cutting part 5. Further, any extra space is not required between the cutter 70 and the guide surface 7C in order to significantly separate the guide surface 7C downstream in the direction D2 from the cutter 70. This contributes to the downsizing of the apparatus in the direction D2.

The pressing surface 7C1 of the guide surface 7C is on the virtual line K2. This enables the pressing surface 7C1 to contact the sheet S in a case where the sheet S is cut at the cutting position P1, and the sheet S is less likely to be deflected. Therefore, the sheet S can be cut more stably.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
In the above-described embodiment, although the cutting part 5 is configured so that the cutter 60 is movable in the left-right direction by the scanning mechanism 52, the cutting part 5 may be constructed of two round blade cutters of which blade portions, respectively, overlap in the direction D1, and a scanning mechanism which moves these two round blade cutters in the left-right direction. Further, the cutting part 5 may be a guillotine-type in which a cutter 60 which is elongated and extends in the left-right direction is moved toward the cutter 70 in the direction D2 to thereby cut a sheet S in the left-right direction, rather than the cutter 60. Also in the above-described cutting parts, by including the first guide 7 having the guide surface 7C, a similar effect to the effect obtained by the above-described embodiment can be obtained.

In the above-described embodiment, the holding part which holds the sheet S at the holding position P2 is the roller pair 3A. The holding part, however, is not limited to this, as long as the holding part is capable of holding the sheet S. In other words, the holding part may be constructed of two parts one of which is a roller and the other of which is a guide surface defining the conveyance path T, or the holding part may be constructed of a pair of guide surfaces holding the sheet S in the thickness direction of the sheet S.

In the above-described embodiment, although the pressing surface 7C1 of the guide surface 7C is disposed on the virtual line K2, the pressing surface 7C1 may be disposed upstream of the virtual line K1 in the direction D2. Namely, the pressing surface 7C1 may be disposed upstream of the virtual line K2 in the direction D2. Further, the pressing surface 7C1 may be disposed upstream of the virtual line K1 and downstream of the virtual line K2 in the direction D2.

In the above-described embodiment, although the printer 1 as the cutting apparatus includes the head 4, etc., the head 4 may be omitted in the cutting apparatus, and the cutting apparatus may be constructed of the casing 1A, the conveyor 3, the cutting part 5, the first guide 7, and the second guide 8. Further, the conveyor 3 may have any configuration as long as the conveyor 3 is capable of conveying the sheet S along the conveyance path.

The first guide 7 may be configured to include solely the pressing surface 7C1 as a single guide surface. Further, the recessed portion 7C2 may be omitted in the first guide surface 7C. Furthermore, the first guide 7 may be fixed to the guide rail 52Y by a member such as a double-sided adhesive tape, rather than the screw 52N.

The second guide 8 may be omitted. Alternatively, the second guide 8 may not be flexible. The opening 1X may be omitted in the casing 1A. Further, the cutter unit 51 may not be configured to be detachably attachable with respect to the carriage 9.

The medium in sheet form is not limited to the paper sheet and may be fabric or plastic film. That is, the sheet medium may be made of any material.

The head 4 as the recording part may eject liquid other than the ink (for example, treatment liquid which agglutinates or precipitates a component of ink, etc.). Further, the recording part is not limited to the liquid ejecting system, and may be of the laser system, the thermal transfer system, etc.

The present disclosure is not limited to the printer, and is applicable also to a facsimile, a copy machine, a multi-function peripheral, etc.

What is claimed is

1. A cutting apparatus comprising:
a casing having a conveyance path for conveying a medium in sheet form;
a conveyor configured to convey the medium along the conveyance path in a conveying direction;
a cutting part including a first cutter configured to contact one surface of the medium which is conveyed by the conveyor, a second cutter configured to contact the other surface of the medium, and a moving mechanism configured to move one or both of the first cutter and the second cutter, the cutting part being configured to cut, with the first cutter and the second cutter, the medium in a first direction intersecting the conveying direction at a cutting position in the conveyance path; and
a first guide having a first guide surface facing the other surface of the medium, wherein
the first cutter has a first base portion and a first end protruding from the first base portion in a second direction intersecting both the conveying direction and the first direction, the first end contacting an end of the second cutter in a case where the cutting part cuts the sheet,
the conveyor has a holding part configured to hold the medium at a holding position downstream of the cutting position in the conveying direction, and
the first guide surface has a portion disposed upstream of a first virtual line in the second direction in a region, in the conveyance path, between the cutting position and an intermediate position which is between the holding position and the cutting position, the first virtual line extending in a third direction orthogonal to both the first direction and the second direction and passing through the first end of the first cutter in the case where the cutting part cuts the sheet.

2. The cutting apparatus according to claim 1, further comprising a supporting part, wherein
the second cutter is a blade extending in the first direction and fixed to the supporting part, and
the moving mechanism is configured to move the first cutter in the first direction.

3. The cutting apparatus according to claim 2, wherein
the second cutter extends in the third direction and defines a portion of the conveyance path, and
the first guide extends in the third direction and is disposed side by side with the second cutter in the second direction.

4. The cutting apparatus according to claim 3, wherein
the first guide is fixed to the supporting part.

5. The cutting apparatus according to claim 4, further comprising a screw fixing the second cutter to the supporting part, wherein
the first guide is fixed to the supporting part with the screw.

6. The cutting apparatus according to claim 3, wherein
a recessed portion, which is recessed downstream in the second direction, is defined in the first guide surface, at a position facing the cutting position in the second direction.

7. The cutting apparatus according to claim 1, wherein
the first guide surface is located on a second virtual line along the conveyance path, the second virtual line connecting the cutting position and the holding position.

8. The cutting apparatus according to claim 1, further comprising a second guide having a second guide surface facing the one surface of the medium at a location upstream of the cutting position in the conveying direction, wherein
the second guide surface is disposed with respect to the conveying direction so that the second guide surface is inclined further downstream in the second direction as the second guide surface extends downstream in the conveying direction.

9. The cutting apparatus according to claim 8, wherein
the second guide is flexible and configured to displace in a direction intersecting the second guide surface.

10. The cutting apparatus according to claim 1, wherein
the casing has an accommodating space accommodating the cutting part and an opening communicating the accommodating space to outside are defined, and
the first cutter is disposed at a position at which the first cutter is closer to the opening than the second cutter is.

11. An image recording apparatus comprising:
a casing having a conveyance path for conveying a medium in sheet form;
a conveyor configured to convey the medium along the conveyance path in a conveying direction;
a recording part configured to record an image on the medium conveyed by the conveyor;
a cutting part including a first cutter configured to contact one surface of the medium which is conveyed by the conveyor, a second cutter configured to contact the other surface of the medium, and a moving mechanism configured to move one or both of the first cutter and the second cutter, the cutting part being configured to cut, with the first cutter and the second cutter, the medium in a first direction intersecting the conveying direction at a cutting position in the conveyance path; and
a first guide having a first guide surface facing the other surface of the medium, wherein
the first cutter has a first base portion and a first end protruding from the first base portion in a second direction intersecting both the conveying direction and the first direction, the first end contacting an end of the second cutter in the case where the cutting part cuts the sheet,
the conveyor has a holding part configured to hold the medium at a holding position upstream of the recording part in the conveying direction and downstream of the cutting position in the conveying direction, and
the first guide surface has a portion disposed upstream of a first virtual line in the second direction in a region, in the conveyance path, between the cutting position and an intermediate position which is between the holding position and the cutting position, the first virtual line extending in a third direction orthogonal to both the first direction and the second direction and passing through the first end of the first cutter in the case where the cutting part cuts the sheet.
